(19) United States
(12) Patent Application Publication
(10) Pub. No.: US 2014/0360984 A1
(43) Pub. Date: Dec. 11, 2014

(54) GAS INSULATED SWITCHGEAR

(71) Applicant: HITACHI, LTD., Tokyo (JP)

(72) Inventors: Tomohiro MORIYAMA, Tokyo (JP); Jun NUKAGA, Tokyo (JP); Toshiaki ROKUNOHE, Tokyo (JP); Masashi KAWAMATA, Tokyo (JP)

(73) Assignee: HITACHI, LTD., Tokyo (JP)

(21) Appl. No.: 14/295,869

(22) Filed: Jun. 4, 2014

(30) Foreign Application Priority Data
Jun. 5, 2013 (JP) 2013-118527

(51) Int. Cl. H01H 33/12

(52) U.S. Cl. CPC H01H 33/12
USPC 218/146

(57) ABSTRACT

Compact lightweight gas insulated switchgear which assures sufficient electrode fixing strength equivalent to the fixing strength given by brazing and is structurally simple and enables efficient arc rotation with low operating energy. In the switchgear, a movable arcing contact is located on a movable element, opposite to a fixed arcing contact and electrically connected to, or disconnected from, the fixed arcing contact as the movable element moves. The movable arcing contact includes, in order from its tip opposite to the fixed arcing contact, a first electrode as a convex hollow coaxial cylindrical electrode, hollow coaxial cylindrical first spacer, and second electrode as a hollow coaxial cylindrical electrode and has electric conduction means to connect the first and second electrodes electrically through the first spacer. The first and second electrodes are fixed through the first spacer by a fixing member having higher resistivity than the first and second electrodes.

### CLAIM OF PRIORITY

The present application claims priority from Japanese Patent application serial no. 2013-118527, filed on Jun. 5, 2013, the content of which is hereby incorporated by reference into this application.

### FIELD OF THE INVENTION

The present invention relates to gas insulated switchgear and more particularly to gas insulated switchgear with arcing contacts which are electrically in contact with each other in a closed state and ignite an arc in an open state.

### BACKGROUND OF THE INVENTION

Generally, in gas insulated switchgear, arcing contacts are provided to prevent an arc discharge generated in the open state from damaging the main contact for electric conduction or the shield and a fixed element side conductor and a movable element side conductor are provided with a given distance between them. A gas insulated switchgear structure is known in which an arcing contact is located on a fixed side conductor and an arcing contact is located on a movable element of a movable side conductor and an elastic contact member is provided on the tip of the fixed side or movable side arcing contact to connect the fixed side and movable side arcing contacts electrically.

Also the use of an electromagnetic force in a magnetic field is known as a method of cutting off the arc discharge in a short time efficiently. For example, the structures based on this method include a structure that uses a permanent magnet, a structure that uses an arc driving coil, and a structure that uses a spiral electrode.

As an example of the structure that uses a permanent magnet, JP-A-2003-346611 describes a structure in which a permanent magnet is located in the center of an arcing contact and a smooth continuous annular arc running path to facilitate the rotation of an arc is located on the tip of the arcing contact so that an arc generated in the open state is ignited on the arc running path and the arc is rotated by the permanent magnet to improve the current interruption performance.

As an example of the structure that uses an arc driving coil, JP-A-2011-142035 describes a structure in which an insulation-coated coil is located between an arcing contact and an end ring (conductor) and the arcing contact, coil and end ring are electrically connected in series and an annular arc running path is provided on the tip of the arcing contact so that an arc generated in the open state is ignited on the arc running path and an interlinked magnetic field for the arc is generated by the arc current flowing into the coil to let the arc rotate along the arc running path to improve the current interruption performance.

As an example of the structure that uses a spiral electrode, JP-A-2008-176942 describes a structure in which virtually disc-shaped spirally-grooved electrodes (spiral electrodes) as arc running paths are located on the tips of fixed side and movable side arcing contacts so that an arc current flows along the spiral electrodes to rotate the arc to improve the current interruption performance.

These types of gas insulated switchgear offer an advantageous effect that the actuator can be compact and light and the operating energy of the actuator can be reduced to ensure high reliability of the switchgear.

Usually an arc-resistant metal is used for arcing contacts to minimize erosion at the time of generation of an arc.

### SUMMARY OF THE INVENTION

However, in the conventional types of gas insulated switchgear which use an electromagnetic arc driving system as described in the above patent documents, brazing work is essential to connect the arc-resistant metal of the arcing contact tip and the other constituent members while ensuring sufficient fixing strength. This poses the problem that skilled labor is required in the manufacture.

In addition, the conventional types of gas insulated switchgear which use an arc driving system has the following problems.

For example, in the arc driving system which uses a permanent magnet, the system must be designed in consideration of deterioration of the permanent magnet over time due to temperature change caused by operating current, or it takes much time and labor to evaluate the deterioration of the permanent magnet, or when an alternating current is interrupted, the system is theoretically unsuitable for efficient arc rotation since the arc rotation direction is reversed every half cycle.

In the arc driving system which uses an arc driving coil, the arc driving coil must be located near the arc source and an insulated structure must be used to prevent current from flowing in the arc driving coil in the steady operation state. This implies that the structure is complicated and has a large outside diameter, thus making it difficult to achieve compactness.

In the arc driving system which uses spiral electrodes, a plurality of tiny slits (spiral grooves) are made in the electrode surface and insulation measures must be taken to prevent an arc from flowing to between slits. In addition, since the spiral electrodes are located on the opposite tips of the arcing contacts on the fixed side and movable side facing each other, springs or similar mechanisms must be provided on the arcing contacts to ensure that the spiral electrodes are last disconnected physically in opening operation. Therefore, the structure concerned is complicated and it is difficult to simplify the manufacturing process.

The present invention has been made in view of the above circumstances and an object thereof is to provide compact lightweight gas insulated switchgear which assures sufficient electrode fixing strength equivalent to the fixing strength given by brazing and is structurally simple and enables efficient arc rotation with low operating energy.

In order to achieve the above object, according to one aspect of the present invention, there is provided gas insulated switchgear with an enclosure forming a gas compartment configured with support insulators and filled with insulating gas. In the switchgear, the enclosure houses: a fixed element side conductor and a movable element side conductor which are supported by the support insulators respectively; a fixed arcing contact fixed on the fixed element side conductor; a fixed side main contact located inside the fixed element side conductor; a movable side main contact located inside the movable element side conductor; a movable element electrically connected to the movable side main contact and the fixed side main contact and movable on an axis line through an actuating rod; and a movable arcing contact which is located on the movable element, opposite to the fixed arcing contact, and electrically connected to, or disconnected from, the fixed arcing contact as the movable element moves. The movable arcing contact includes, in order from its tip opposite to the fixed arcing contact, a first electrode as a convex hollow coaxial cylindrical electrode, a hollow coaxial cylindrical first spacer, and a second electrode as a hollow coaxial cylindrical electrode, and has electric conduction means to connect the first electrode and the second electrode electrically through the first spacer; and the first electrode and the second electrode are fixed through the first spacer by a fixing member which has higher resistivity than the first electrode and the second electrode.

According to another aspect of the invention, in the switchgear, the movable arcing contact includes, in order from its tip opposite to the fixed arcing contact, a first electrode as a convex hollow coaxial cylindrical electrode and a second electrode as a hollow coaxial cylindrical electrode, the first electrode and the second electrode are fixed by a fixing member, an annular arc running path is provided on a convex portion tip of the first electrode, and a fourth slit is formed in a circumferential direction extending obliquely from the arc running path of the first electrode as a starting point toward a direction opposite to the arc running path.

According to the present invention, there is provided compact lightweight gas insulated switchgear which assures sufficient electrode fixing strength equivalent to the fixing strength given by brazing and is structurally simple and enables efficient arc rotation with low operating energy.

### BRIEF DESCRIPTION OF THE DRAWINGS

FIG. 1 is a schematic sectional view showing the general structure of gas insulated switchgear according to a first embodiment of the present invention;

FIG. 2 is a fragmentary schematic sectional view showing the closed state of the gas insulated switchgear according to the first embodiment;

FIG. 3 is a perspective view showing details of a movable arcing contact as an essential component of the gas insulated switchgear shown in FIG. 2;

FIG. 4 is an enlarged sectional view showing essential fixing components to illustrate the method of fixing the movable arcing contact shown in FIG. 3;

FIG. 5 is a fragmentary schematic sectional view showing the gas insulated switchgear shown in FIG. 2 in which opening operation is under way;

FIG. 6 is a fragmentary schematic sectional view showing the open state of the gas insulated switchgear shown in FIG. 2;

FIG. 7 is a view illustrating the method of fixing the movable arcing contact of gas insulated switchgear according to a second embodiment of the present invention, which corresponds to FIG. 4;

FIG. 8 is a view showing details of the movable arcing contact of gas insulated switchgear according to a third embodiment of the present invention, which corresponds to FIG. 3;

FIG. 9 is a sectional view illustrating the method of fixing the movable arcing contact of gas insulated switchgear according to the third embodiment, which corresponds to FIG. 4;

FIG. 10 is a view showing details of the movable arcing contact of gas insulated switchgear according to a fourth embodiment of the present invention, which corresponds to FIG. 3; and

FIG. 11 is a view showing details of the movable arcing contact of gas insulated switchgear according to a fifth embodiment of the present invention, which corresponds to FIG. 3.

### DETAILED DESCRIPTION OF THE PREFERRED EMBODIMENTS

Next, gas insulated switchgear according to the preferred embodiments of the present invention will be described referring to the accompanying drawings. In the drawings that illustrate the preferred embodiments, the same elements are designated by the same reference numerals.

### First Embodiment

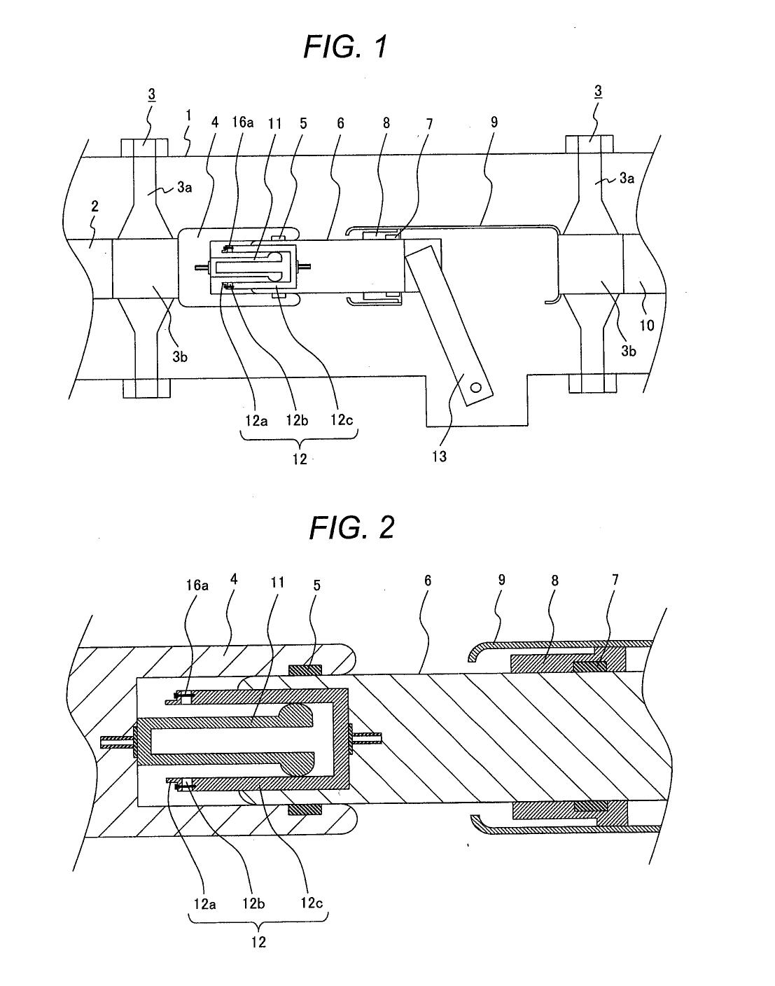

FIG. 1 is a sectional view showing the closed state of gas insulated switchgear according to the first embodiment of the present invention.

As shown in the figure, in the gas insulated switchgear according to this embodiment, a gas compartment is formed by support insulators 3 in an enclosure 1 and electronegative gas such as SF₆ gas, dry air, nitrogen, carbon dioxide, SF₆/N₂ gas mixture containing electronegative gas, N₂/O₂ gas mixture not containing electronegative gas or the like is filled as insulating gas in this gas compartment.

The support insulators 3 each have an insulator 3a in the periphery and an embedded conductor 3b in the center and a fixed element side conductor 4 and a movable element side conductor 9 facing each other are supported and fixed on the embedded conductors 3b in a way that they are electrically isolated from the enclosure 1 and spaced by a given insulation distance. The opposite portions of the fixed element side conductor 4 and movable element side conductor 9 are curved, thereby offering an electric field moderating shield effect.

A movable element 6, located on the movable element side conductor 9 side, is designed to be movable on its axis through an insulated actuating rod 13 by means of an external actuator (not shown). A movable element side conductor conducting part 8 and a movable side main contact 7 are located inside the movable element side conductor 9 and the movable side main contact 7 keeps the movable element 6 electrically connected with the movable element side conductor 9.

On the other hand, a fixed side main contact 5 is located inside the fixed element side conductor 4 and in the closed state, the fixed side main contact 5 comes into contact with the movable element 6, and a fixed side conductor 2 and a movable side conductor 10, which are connected to the embedded conductors 3b supporting them, constantly maintain electrical connection between the fixed side and movable side.

FIG. 2 shows an essential part of the gas insulated switchgear shown in FIG. 2 in enlarged form.

As shown in the figure, a fixed arcing contact 11 is located inside the virtually hollow and cylindrical fixed element side conductor 4 which is opposite to the movable side. The fixed arcing contact 11, having a semispherical current collector at its tip, is virtually hollow and cylindrical and a plurality of slits are made therein in the axis line direction so that it is radially elastic.

In the closed state, due to the elasticity of the fixed arcing contact 11, the inner surface of the movable arcing contact 12 and the semispherical current collector of the fixed arcing contact 11 are electrically connected, with the movable element 6 and hollow cylindrical movable arcing contact 12 inserted in the fixed element side conductor 4.

Though described in detail later, in the movable arcing contact 12, a convex electrode 12a with a C-shaped slit (not shown) as a first electrode and a first spacer 12b are stacked on its tip opposite to the fixed side and they both are supported and fixed on a cylindrical electrode 12c as a second electrode by fixing members 16a. The large-diameter portion (other than the convex portion) of the convex electrode 12a with a larger diameter than the convex portion, and the spacer 12b have the same diameter as the cylindrical electrode 12c, and the convex electrode 12a and the cylindrical electrode 12c are electrically connected by an electric conduction member as an electric conduction means (not shown).

In the closed state of the gas insulated switchgear, the movable arcing contact 12 on the opposite side tip of the movable element 6 is inserted in the fixed element side conductor 4 together with the movable element 6 and while it is inserted in this way, a current pathway is formed from the fixed element side conductor 4 through the fixed side main contact 5, movable element 6, movable side main contact 7, and movable element side conductor conducting part 8 to the movable element side conductor 9 and also a current pathway is formed from the fixed element side conductor 4 through the fixed arcing contact 11, movable arcing contact 12, movable element 6, movable side main contact 7, and movable element side conductor conducting part 8 to the movable element side conductor 9.

Consequently, temperature rise due to contact resistance during electric conduction is less than when the fixed arcing contact 11 and movable arcing contact 12 are not provided.

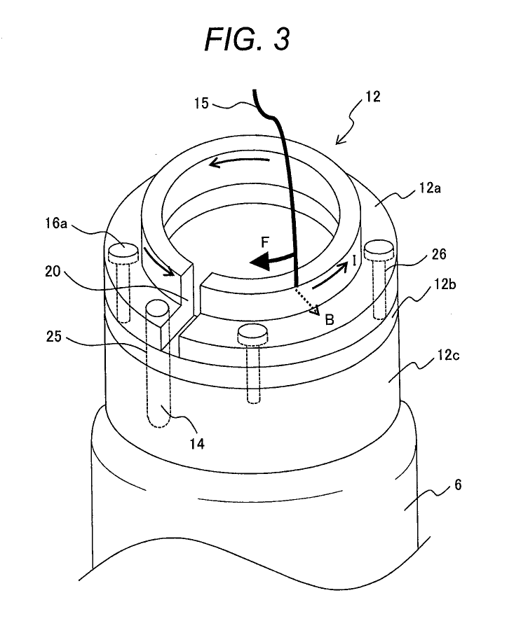

Next, the concrete structure of the movable arcing contact 12 will be described referring to FIG. 3. FIG. 3 is a perspective view of the movable arcing contact 12 as seen from its opposite tip side.

As shown in the figure, in the movable arcing contact 12 in this embodiment, the hollow coaxial cylindrical convex electrode 12, hollow coaxial cylindrical spacer 12b, and hollow coaxial cylindrical electrode 12c are stacked in order from its tip opposite to the fixed side and supported and fixed by the insulating fixing members 16a and mounted on the movable element 6. Part of the convex electrode 12a (annular electrode) is divided by the slit 20 in the circumferential direction. On the other hand, the spacer 12b and cylindrical electrode 12c have the shape of a cylindrical ring and they are not divided in their circumferential direction.

The end of the convex electrode 12a near the slit 20 and the cylindrical electrode 12c are connected by an electric conduction member 14 which passes through a through hole 25 in the convex electrode 12a and spacer 12b and reaches a hole in the cylindrical electrode 12c and the convex electrode 12a and cylindrical electrode 12c are electrically conductive to each other through the electric conduction member 14.

FIG. 3 also shows an arc 15 generated in the closed state of the gas insulated switchgear. In the open state of the gas insulated switchgear, the arc 15 shown in FIG. 3 is generated between the tip of the fixed arcing contact 11 and the movable arcing contact 12 which are shown in FIG. 2.

The arc 15 is rotated on the convex portion of the convex electrode 12a as an arc running path, in the circumferential direction of the small-diameter portion with a smaller diameter than the large-diameter portion. In other words, due to the arc 15, current I flows on the small-diameter portion in the circumferential direction and current I generates a magnetic field B so that an electromagnetic force F is generated in the arc 15 along the circumferential direction of the convex electrode 12a and the electromagnetic force F rotates the arc 15.

Current I flows on the small-diameter portion of the convex electrode 12a in the circumferential direction and then it flows toward the cylindrical electrode 12c through the electric conduction member 14.

In this embodiment, it is desirable to use a nonmagnetic material with a lower electric conductivity (or higher electric resistivity) than the convex electrode 12a and cylindrical electrode 12c for the spacer 12b: for example, stainless steel or an insulating material such as PTFE is desirable.

This ensures that current I flows on the small-diameter portion of the convex electrode 12a in the circumferential direction. Also, since the electric conduction member 14 is partially covered by the spacer 12b, it is unlikely that an arc 15 is generated on a lateral side of the electric conduction member 14 and it is also unlikely that the spacer 12b distorts the magnetic field B to generate an electromagnetic force to rotate the arc 15.

Next, one example of the method of manufacturing the movable arcing contact 12 in this embodiment will be explained. Since the arc 15 directly runs on the convex electrode 12a as a component of the movable arcing contact 12, the convex electrode 12a should be made of a material which has high resistance to erosion due to the arc 15 and high electric conductivity and it is desirable to use a so-called arc-resistant metal such as copper-tungsten. On the other hand, since the cylindrical electrode 12c is not directly exposed to the arc 15, desirably it is made of a material with high electric conductivity such as copper and aluminum.

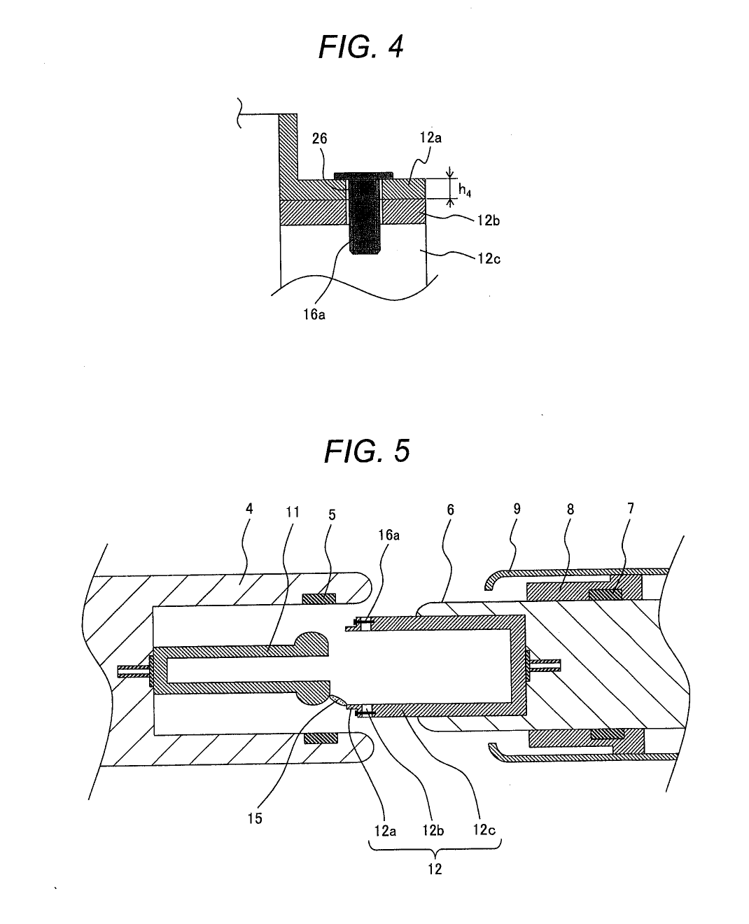

As mentioned above, the spacer 12b and convex electrode 12a are laid over the hollow cylindrical electrode 12c sequentially and a hole 26 is previously made in the convex electrode 12a, spacer 12b, and cylindrical electrode 12c so that an insulating fixing member 16a (epoxy, alumina, etc.) can penetrate the hole or can be fixed in the hole. As shown in FIG. 4, after the convex electrode 12a, spacer 12b, and cylindrical electrode 12c are stacked, the insulating fixing member 16a is placed in the hole 26 and the convex electrode 12, spacer 12b, and cylindrical electrode 12c are securely fixed by caulking with the insulating fixing member 16a or screwing.

In the convex electrode 12a thus structured, the small-diameter portion functions as a running path for the arc 15 and the large-diameter portion functions as a fixing portion.

Consequently, even if the spacer 12b is made of metal such as SUS or an insulating material such as PTFE, an electrode fixing strength equivalent to that achieved by the conventional technique can be easily achieved by caulking with the insulating fixing member 16a or fixing with screws, without the need for brazing work which would be needed in the conventional technique. In addition, since the insulating fixing member 16a is not exposed to an arc, the movable arcing contact 12 contributes largely to prevention of erosion of the insulating fixing member 16a due to the arc 15.

Although as the material of the electric conduction member 14 it is desirable to use a material with high erosion resistance and high electric conductivity such as an arc-resistant metal, if the current of the arc 15 is small, it may be made of another material with high electric conductivity such as copper.

Other procedures of making the convex electrode 12a include deposition by spraying, dipping, or evaporation. If spraying is adopted, deposition may be made by spraying metal or insulating material.

Specifically, one possible procedure is as follows: the convex electrode 12a is made of a material with high electric conductivity such as copper like the cylindrical electrode 12c and arc-resistant metal powder is deposited by spraying the tip of the small-diameter portion of the convex electrode 12a as a target. In this case, the other portions of the convex electrode 12a should be masked in advance to prevent deposition on these portions.

Next, how current interruption takes place when the gas insulated switchgear is in the open state will be described.

As an opening operating energy is given to the movable element 6 by turning the insulated actuating rod 13 clockwise in the closed state shown in FIG. 1 through the external actuator (not shown), the movable element 6 moves right toward the opening direction on the axis line. As the movable element 6 moves right toward the opening direction on the axis line, first the movable element 6 leaves the fixed side main contact 5 (FIG. 2) and the current pathway in which current flows through the fixed side main contact 5 is interrupted. However, at this moment, the fixed arcing contact 11 and movable arcing contact 12 are in contact with each other and thus the current pathway which includes both the arcing contacts is not interrupted.

After that, as shown in FIG. 5, the movable arcing contact 12 moves further right and leaves the fixed arcing contact 11 and an arc 15 is generated between the opposite tips of the fixed arcing contact 11 and movable arcing contact 12.

The arc 15 receives an electromagnetic force F because of the structure of the movable arcing contact 12 and interruption current (arc current) and rotates on the C-shaped arc running path of the small-diameter portion of the convex electrode 12a and undergoes the cooling effect of insulating gas so that the arc is extinguished at the current zero point and current interruption is completed.

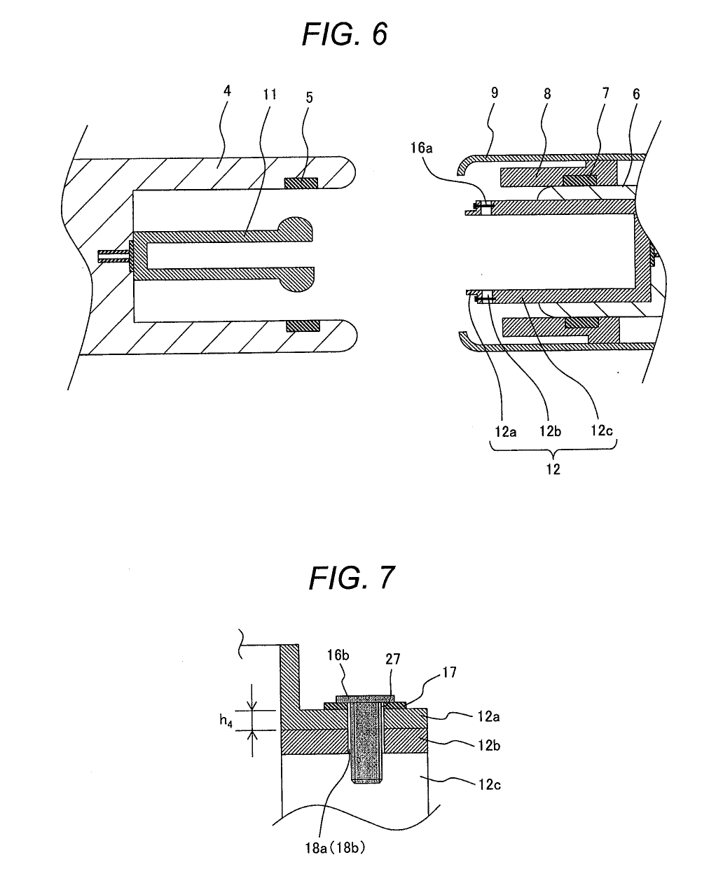

When the opening operation is finished, as shown in FIG. 6 the movable element 6 moves and stays inside the movable element side conductor 9 which has an electric field moderating shield effect at its opposite tip. Although the opposite tips of the fixed arcing contact 11 and movable arcing contact 12 are each shaped to allow electric fields to concentrate there easily, in the open state the fixed arcing contact 11 and movable arcing contact 12 are inside the fixed element side conductor 4 and movable element side conductor 9 respectively and thus the electric fields of the fixed arcing contact 11 and movable arcing contact 12 are held at a low level and insulation between the poles is properly maintained.

Therefore, according to this embodiment, since the convex electrode 12a is employed and the insulating fixing members 16a are fitted to the large-diameter portion of the convex electrode 12a, an electrode fixing strength equivalent to that of the movable arcing contact 12 fixed by the conventional brazing process is easily achieved and erosion of the insulating fixing members 16a is substantially reduced and the arc 15 can be rotated efficiently with a simpler structure than the conventional structure. Thus, the embodiment provides compact lightweight gas insulated switchgear in which the operating energy is low.

### Second Embodiment

FIG. 7 is an enlarged sectional view of an essential part of gas insulated switchgear according to the second embodiment of the present invention, which shows another fixing method and corresponds to FIG. 4.

This embodiment concerns a variation of the method of fixing the convex electrode 12a and spacer 12b to the cylindrical electrode 12c according to the first embodiment. Next, what is different from the first embodiment will be explained.

The second embodiment shown in FIG. 7 is characterized in that fixing members 16b of metal such as SUS are used to fix the convex electrode 12a and spacer 12b to the cylindrical electrode 12c to provide a higher fixing strength than the insulating fixing members 16a in the first embodiment.

More specifically, in the second embodiment, as shown in FIG. 7, the metal fixing members 16b are used to fix the convex electrode 12a and spacer 12b to the cylindrical electrode 12c and an insulating washer 17 of PTFE or the like as a second spacer is put between each metal fixing member 16b and the large-diameter portion of the convex electrode 12a and the convex electrode 12a is securely fixed to the cylindrical electrode 12c by tightening the metal fixing members 16b through the washers 17.

Furthermore, the metal fixing members 16b are in contact with the cylindrical electrode 12c and are electrically isolated from the convex electrode 12a. Therefore, arc current does not flow from the convex electrode 12a to the cylindrical electrode 12c through the metal fixing members 16b and the electromagnetic force F is not interrupted.

In order to further improve the reliability of insulation between the convex electrode 12a and cylindrical electrode 12c, an insulating tube 18a as a fourth spacer should be fitted at least in a through hole 27 with height h₄ made in the large-diameter portion of the convex electrode 12a or the portion of the metal fixing member 16b placed in the through hole 27 should be covered by insulating tape 18b or the like as a fourth spacer. As the material of the insulating tube 18a or insulating tape 18b, PTFE, which has high heat resistance and high workability, is desirable.

The second embodiment not only brings about the same advantageous effect as the first embodiment but also fixes the convex electrode 12a to the cylindrical electrode 12c more securely than the first embodiment because of the presence of the washers 17 between the metal fitting members 16b and the large-diameter portion of the convex electrode 12a.

### Third Embodiment

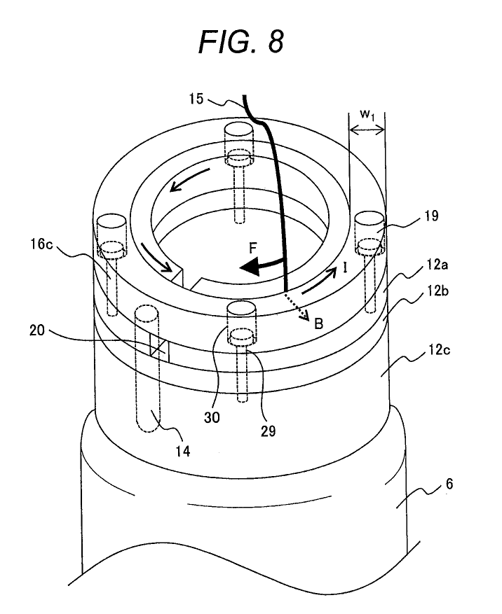

FIG. 8 is a perspective view of the movable arcing contact 12 of gas insulated switchgear according to the third embodiment as seen from its opposite tip side.

This embodiment concerns another variation of the method of fixing the convex electrode 12a and spacer 12b to the cylindrical electrode 12c in the first or second embodiment of the present invention. Next, what is different from the second embodiment will be explained.

As shown in FIG. 8, the third embodiment is characterized in that an annular (cylindrical) insulating fixing spacer 19 as a third spacer is located in the area with width w₁ equivalent to the distance between the outside circumference of the large-diameter portion of the convex electrode 12a and the outside circumference of its small-diameter portion and the convex electrode 12a and spacer 12b are fixed to the cylindrical electrode 12c using the fixing spacer 19.

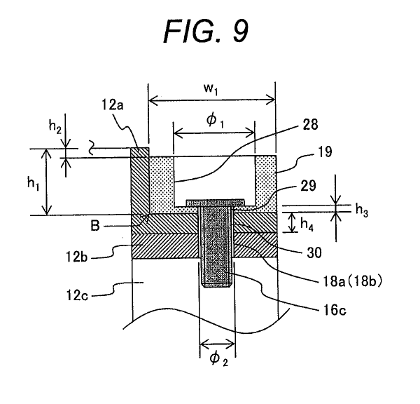

The fixing method is described below in detail referring to FIG. 9. FIG. 9 is an enlarged sectional view of the fixing member 16c for fixing the convex electrode 12a and spacer 12b to the cylindrical electrode 12c as shown in FIG. 8 and its vicinity.

As shown in FIG. 9, the annular insulating fixing spacer 19 in this embodiment has a width of (outside diameter-inside diameter)/2=w₁ and a height of (h₁-h₂) which is less than height h₁ of the small-diameter portion of the convex electrode 12a from its large-diameter portion surface. The insulating fixing spacer 19 has a first hole 28 having a height of (h₁-h₂-h₃) or the spacer height minus thickness h₃, and a diameter Φ₁, in the place where the fixing member 16c is placed. Also the spacer 19 has a second hole (through hole) 29 with a diameter Φ₂ which is smaller than the diameter Φ₁. Consequently the fixing spacer 19 is fixed to the large-diameter portion of the convex electrode 12a by passing the fixing members 16c through the first holes 28 with the diameter Φ₁ and the second holes 29 with the diameter Φ₂.

As the material of the insulating fixing spacer 19, it is desirable to use a material having lower electric conductivity than the convex electrode 12a and cylindrical electrode 12c as the material of the spacer 12b. For example, a material with high heat resistance and high workability such as PTFE is desirable.

On the other hand, for the fixing member 16c, an insulating material or metal material may be used, but from the viewpoint of fixing strength and long-term reliability a metal material is more desirable. If the metal fixing member 16c is used, as in the second embodiment, in order to further improve insulation reliability, an insulating tube 18a as a fourth spacer should be placed at least in a through hole 30 with a height h₄ in the large-diameter portion of the convex electrode 12a or the portion of the metal fixing member 16c placed in the through hole 30 should be covered by insulating tape 18b or the like as a fourth spacer.

The third embodiment not only brings about the same advantageous effect as the second embodiment but also fixes the convex electrode 12a to the cylindrical electrode 12c more securely than the second embodiment because contact pressure is applied to the entire large-diameter portion of the convex electrode 12a by the fixing members 16c and insulating fixing spacer 19. In addition, since the insulating fixing spacer 19 has a height of (h₁-h₂) and is fixed in contact with the lateral side of the small-diameter portion of the convex electrode 12a and its large-diameter portion, stress concentration on corner B (FIG. 9) of the convex electrode 12a is relieved in opening or closing operation and the thickness of the large-diameter portion of the convex electrode 12a, equivalent to the height h₄, may be decreased. Also, since the insulating fixing spacer 19 has a height of (h₁-h₂), even when the metal fixing member 16c is used, the possibility of the arc 15 flowing to the metal fixing members 16c is reduced. Also, since the top surface of the insulating fixing spacer 19 is lower than the surface on which the arc 15 runs, deterioration due to the arc 15 is suppressed.

In other words, the third embodiment easily achieves an electrode fixing strength equivalent to that of the movable arcing contact 12 fixed by the conventional brazing process and contributes to compactness of the movable arcing contact 12. Also since the large-diameter portion of the convex electrode 12a is thin (equivalent to height h₄), the density of current I is higher and the electromagnetic force F increases, so the arc 15 can be rotated more efficiently than in the first and second embodiments.

### Fourth Embodiment

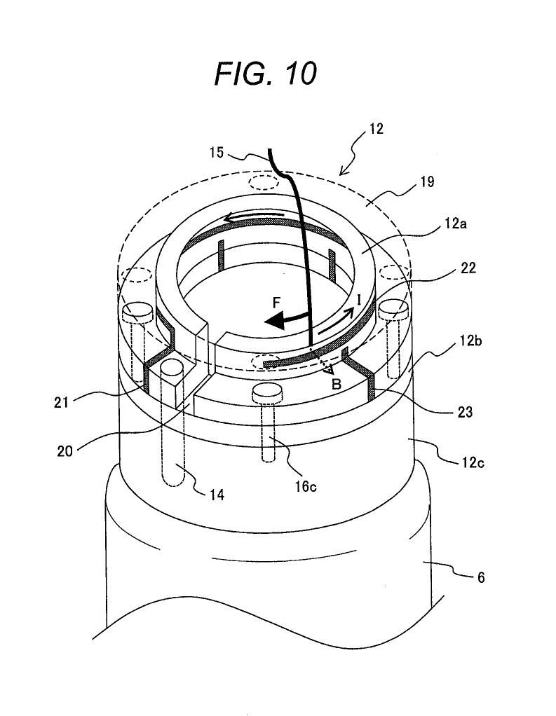

FIG. 10 is a perspective view of the movable arcing contact 12 of gas insulated switchgear according to the fourth embodiment as seen from its opposite tip side. The figure illustrates an example of the fourth embodiment in which the same insulating fixing spacer 19 as in the third embodiment is used and for illustration convenience, the insulating fixing spacer 19 is indicated by broken line in the figure.

This embodiment concerns another variation of the method of fixing the convex electrode 12a and spacer 12b to the cylindrical electrode 12c in any one of the first to third embodiments of the present invention. Next, what is different from the third embodiment will be explained.

The fourth embodiment shown in FIG. 10 is characterized in that vertical slits 21 and 23 as second slits are formed, extending in the height direction of the convex electrode 12a and a slit 22 as a third slit is formed, extending in the circumferential direction of the convex electrode 12a. The other elements are the same as in the third embodiment.

In the fourth embodiment, the vertical slit 21 extending in the height direction of the convex electrode 12a is located near an electric conduction member 14 in a way to sandwich the electric conduction member 14 with the slit 20 of the C-shaped convex electrode 12a. Also a circumferential slit 22 extending in the circumferential direction of the convex electrode 12a is shaped so as to join the end of the vertical slit 21 near the tip of the movable arcing contact 12. Also, the vertical slit 23 extending in the height direction of the convex electrode 12a has such a length that its end near the tip of the movable arcing contact 12 does not reach the circumferential slit 22 extending in the circumferential direction. The figure shows an example of the fourth embodiment in which three vertical slits 23 are formed in the circumferential direction.

The fourth embodiment not only brings about the same advantageous effect as the third embodiment but also reduces dispersion of current I toward the height direction (front surface side) of the convex electrode 12a thanks to the vertical slits 21 and 23. Furthermore, since the circumferential slit 22 enables current I to concentrate near the opposite tip of the fixed arcing contact 11, the arc 15 can be rotated more efficiently than in the first to third embodiments.

In the fourth embodiment shown in the figure, the vertical slits 21 and 23 and circumferential slit 22 are all formed in the convex electrode 12a. Alternatively the vertical slits 21 and 23 and circumferential slit 22 may be formed independently or the vertical slit 21 and circumferential slit 22 may be formed continuously.

### Fifth Embodiment

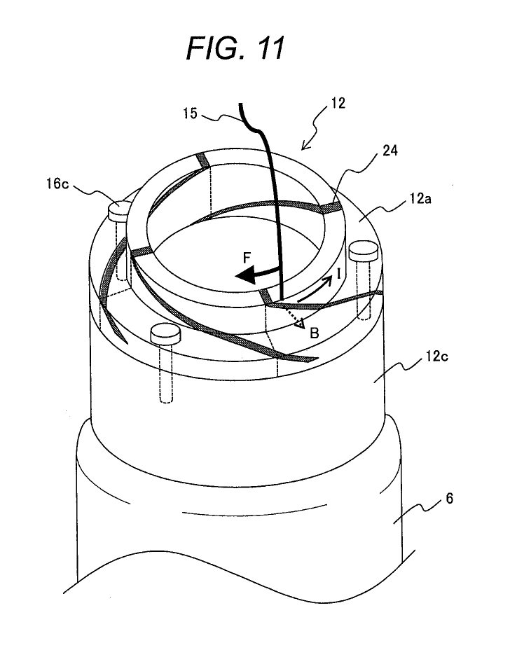

FIG. 11 is a perspective view of the movable arcing contact 12 of gas insulated switchgear according to the fifth embodiment as seen from its opposite tip side.

This embodiment concerns another variation of the method of fixing the convex electrode 12a and spacer 12b to the cylindrical electrode 12c in any one of the first to fourth embodiments of the present invention. Next, what is different from the fourth embodiment will be explained.

The fifth embodiment shown in FIG. 11 is characterized in that the spacer 12b used in the first to fourth embodiments is eliminated and the convex electrode 12a is directly fixed to the cylindrical electrode 12c using the fixing members 16c and also that the slit 20 in the convex electrode 12a is eliminated and an oblique slit 24 is newly formed to let current I flow in the circumferential direction to obtain rotation driving force F.

In this embodiment, an oblique slit 24 extends from the small-diameter portion surface of the convex electrode 12a as the arc running surface to its large-diameter portion, though the slit does not completely divide the convex electrode 12a. Although in this example, four oblique slits 24 are arranged at intervals of approximately 90 degrees, the number of oblique slits is not limited. However, when one oblique slit 24 is formed, it is desirable that the total slit angle be 360 degrees or more in the area from the tip of the small-diameter portion of the convex electrode 12a to its large-diameter portion.

If a plurality of oblique slits 24 are formed, it is desirable that the large-diameter portion side end of one oblique slit 24 should extend beyond the line segment (indicated by dotted line) vertical to the starting point of an adjacent oblique slit 24 on the small-diameter portion of the convex electrode 12a. The reason is that when oblique slits are so arranged, current I hardly flows vertically from the small-diameter portion of the convex electrode 12a and flows in the circumferential direction of the convex electrode 12a. As a result, rotation driving force F can be obtained.

This embodiment has been described above in comparison with the first to fourth embodiments. This embodiment may include the insulating fixing spacer 19 (FIG. 9) to relieve stress concentration on the corner B of the convex electrode 12a in opening or closing operation and decrease the thickness of the large-diameter portion of the convex electrode 12a, equivalent to height h₄.

According to this embodiment, since the convex electrode 12a is directly fixed to the cylindrical electrode 12c by the fixing members 16c, an electrode fixing strength equivalent to that of the movable arcing contact 12 fixed by the conventional brazing process is easily achieved and due to the oblique slit 24, the arc 15 can be rotated efficiently with a simpler structure than the conventional structure. Thus, the embodiment provides compact lightweight gas insulated switchgear in which the operating energy is low.

The present invention is not limited to the above embodiments and includes other various forms of embodiments. The above embodiments have been explained in detail for easy understanding of the present invention, but an embodiment of the invention need not include all the elements of the above embodiments. Some elements of an embodiment may be replaced by elements of another embodiment or elements of an embodiment may be added to another embodiment. Also, in an embodiment, addition of other elements, or deletion or replacement of elements is possible.

### REFERENCE SIGNS LIST

1 . . . Enclosure
2 . . . Fixed side conductor
3 . . . Support insulator
3a . . . Insulator
3b . . . Embedded conductor
4 . . . Fixed element side conductor
5 . . . Fixed side main contact
6 . . . Movable element
7 . . . Movable side main contact
8 . . . Movable element side conductor conducting part
9 . . . Movable element side conductor
10 . . . Movable side conductor
11 . . . Fixed arcing contact
12 . . . Movable arcing contact
12a . . . Convex electrode
12b . . . Spacer
12c . . . Cylindrical electrode
13 . . . Insulated actuating rod
14 . . . Electric conduction member
15 . . . Arc
16a . . . Insulating fixing member
16b . . . Metal fixing member
16c . . . Fixing member
17 . . . Washer
18a . . . Insulating tube
18b . . . Insulating tape
19 . . . Fixing spacer
20 . . . Slit
21, 23 . . . Vertical slit
22 . . . Circumferential slit
24 . . . Oblique slit
25, 27, 30 . . . Through hole
26 . . . Hole
28 . . . First hole
29 . . . Second hole

What is claimed is:

1. Gas insulated switchgear comprising an enclosure forming a gas compartment configured with support insulators and filled with insulating gas, the enclosure housing:
a fixed element side conductor and a movable element side conductor which are supported by the support insulators respectively;
a fixed arcing contact fixed on the fixed element side conductor;
a fixed side main contact located inside the fixed element side conductor;
a movable side main contact located inside the movable element side conductor;
a movable element electrically connected to the movable side main contact and the fixed side main contact and movable on an axis line through an actuating rod; and
a movable arcing contact which is located on the movable element, opposite to the fixed arcing contact, and is electrically connected to, or disconnected from, the fixed arcing contact as the movable element moves,
wherein the movable arcing contact comprises, in order from a tip thereof opposite to the fixed arcing contact, a first electrode as a convex hollow coaxial cylindrical electrode, a hollow coaxial cylindrical first spacer, and a second electrode as a hollow coaxial cylindrical electrode, and has electric conduction means to connect the first electrode and the second electrode electrically through the first spacer; and
wherein the first electrode and the second electrode are fixed through the first spacer by a fixing member which has higher resistivity than the first electrode and the second electrode.

2. The gas insulated switchgear according to claim 1,
wherein the first electrode has an annular arc running path and includes at least one slit which divides part of the first electrode in a circumferential direction thereof.

3. The gas insulated switchgear according to claim 1,
wherein the first spacer has higher resistivity than the first electrode and the second electrode.

4. The gas insulated switchgear according to claim 1,
wherein the fixing member is made of an insulating material having higher resistivity than the first electrode and the second electrode.

5. The gas insulated switchgear according to claim 1,
wherein the fixing member is made of metal material and a second spacer having higher resistivity than the first electrode and the second electrode is interposed between the fixing member and the first electrode.

6. The gas insulated switchgear according to claim 5,
wherein the second spacer is an insulating washer.

7. The gas insulated switchgear according to claim 1,
wherein a cylindrical third spacer having the same outer surface as a large-diameter portion of the first electrode and the same inner surface as an outside surface of a small-diameter portion of the first electrode is located in contact with the large-diameter portion of the first electrode concentrically with the first electrode.

8. The gas insulated switchgear according to claim 7,
wherein the third spacer is lower in height than a convex portion including a small-diameter portion surface of the first electrode;
wherein a first hole thinner than the third spacer and having a larger inside diameter than the fixing member is formed in a place of the third spacer where the fixing member is placed; and
wherein a second hole having a smaller diameter than the first hole is formed in an end of the third spacer in contact with a large-diameter portion surface from the first hole; and
wherein the fixing member is placed by being passed through the first hole and the second hole.

9. The gas insulated switchgear according to claim 8,
wherein a fourth spacer made of a material having higher resistivity than the first electrode and the second electrode is placed in a through hole of the first electrode in which the fixing member is inserted.

10. The gas insulated switchgear according to claim 9,
wherein the fourth spacer is an insulating tube or insulating tape.

11. The gas insulated switchgear according to claim 1,
wherein the first electrode has at least one second slit along a height direction of the first electrode.

12. The gas insulated switchgear according to claim 1,
wherein a third slit is formed in part of the first electrode in a circumferential direction thereof along the circumferential direction.

13. Gas insulated switchgear comprising an enclosure forming a gas compartment configured with support insulators and filled with insulating gas, the enclosure housing:
a fixed element side conductor and a movable element side conductor which are supported by the support insulators respectively;
a fixed arcing contact fixed on the fixed element side conductor;
a fixed side main contact located inside the fixed element side conductor;
a movable side main contact located inside the movable element side conductor;
a movable element electrically connected to the movable side main contact and the fixed side main contact and movable on an axis line through an actuating rod; and
a movable arcing contact which is located on the movable element, opposite to the fixed arcing contact, and is electrically connected to, or disconnected from, the fixed arcing contact as the movable element moves,
wherein the movable arcing contact comprises, in order from a tip thereof opposite to the fixed arcing contact, a first electrode as a convex hollow coaxial cylindrical electrode and a second electrode as a hollow coaxial cylindrical electrode;
wherein the first electrode and the second electrode are fixed by a fixing member;
wherein an annular arc running path is provided on a convex portion tip of the first electrode; and
wherein a fourth slit is formed in a circumferential direction, extending obliquely from the arc running path of the first electrode as a starting point toward a direction opposite to the arc running path.

14. The gas insulated switchgear according to claim 13,
wherein a plurality of the fourth slits are provided and in the circumferential direction of the first electrode, each of the fourth slits extends so that an end point thereof is beyond a slit starting point of an adjacent one of the fourth slits which starts from the arc running path.
